(19) United States
(12) Patent Application Publication
(10) Pub. No.: US 2006/0045461 A1
(43) Pub. Date: Mar. 2, 2006

(54) Methods and apparatus for project management

(75) Inventor: Robert Y. Oikawa, Redmond, WA (US)

Correspondence Address: Randy J. Pritzker;Wolf, Greenfield & Sacks, P.C., 600 Atlantic Avenue, Boston, MA, 02210-2206, US

(73) Assignee: Microsoft Corporation, Redmond, WA (US)

(21) Appl. No.: 10/912,873

(22) Filed: Aug. 6, 2004

(51) Int. Cl. H04N 5/91

(52) U.S. Cl. 386/46

(57) ABSTRACT

Embodiments of the present invention are directed to project management. In one embodiment, a process model may be defined in a programming language. The process model may include an executable specification of the process and the executable specification may be executed to simulate the process. Executing the specification may also result in the generation of project management artifacts, such as a budget and a project schedule.

### FIELD OF THE INVENTION

The present invention relates to project management.

### DESCRIPTION OF THE RELATED ART

Managing a large project may present many challenges. For example, when managing the development of a software product, difficulties may arise with respect to cost, scheduling, manpower, organization, and quality. Typically, a project plan is created at the beginning of the development effort to define a strategy for completion of the product that meets acceptable time, cost, and quality requirements. The project plan may, for example, define a budget, set a development schedule, define quality requirements for the product, and assign roles and responsibilities to developers.

In an ideal situation, exactly following the project plan will result in a product that the meets the specified quality requirements and is produced on time and within budget. However, in practice quality, cost, and time goals may be difficult to achieve as time and cost requirements may be hard to accurately estimate in the early stages of development. Further, the development process itself may reveal requirements for the product that were not initially considered. These requirements may introduce additional time and expense into the development process.

As a result, initial projects are often deficient and thus are reviewed and revised throughout the development process to account for problems that are encountered during the development process. The initial plans and schedules may include a number of artifacts that define aspects of the project (e.g., Gantt Charts, flow charts, budget documents) and each of these may require updating when a problem arises that necessitates revision of the project plan. The generation and updating of these artifacts is typically performed using software tools that generate documents based on manual (i.e., human) input and manipulation of data. Thus, project management often requires significant time and effort throughout the development process.

### SUMMARY OF THE INVENTION

One embodiment is directed to a method of managing a project comprising acts of: defining a process model for a process in a programming language, wherein the process model includes an executable specification of the process; and executing the specification on a computer system to simulate the process.

Another embodiment is directed to at least one computer readable medium encoded with instructions that, when executed on a computer system, perform a method of managing a project comprising acts of: accepting as an input a process model for a process, wherein the process model includes an executable specification of the process; and simulating the process by executing the specification on the computer system.

A further embodiment is directed to an apparatus for use in managing a project comprising: an input adapted to receive an executable specification of a process; and at least one controller adapted to simulate the process by executing the specification.

The summary provided above is intended to provide a basic understanding of the disclosure to the reader. This summary is not an exhaustive or limiting overview of the disclosure and does not define or limit the scope of the invention in any way. The invention is limited only as defined by the claims and the equivalents thereto

### BRIEF DESCRIPTION OF THE DRAWINGS

FIG. 1 is a flow chart illustrating a method of project management, in accordance with one embodiment of the invention;

FIG. 2 is a UML class diagram of an illustrative process definition in accordance with one embodiment of the invention;

FIG. 3 is a UML class diagram of an illustrative process definition in accordance with one embodiment of the invention;

FIG. 4A is a timeline illustrating sequential execution of tasks;

FIG. 4B is a timeline illustrating parallel execution of tasks; and

FIG. 5 is an example of an artifact that may be generated by an executable specification, in accordance with one embodiment of the invention;

### DETAILED DESCRIPTION

Project planning presents challenges such as estimating costs and realizable project schedules. Thus, one embodiment of the invention is directed to modeling a process and simulating the process on a computer system. By simulating the process, a better understanding of the cost and time requirements of the project may be achieved. As used herein, a project is any undertaking that has at least one defined goal. The goal of the project may be any suitable goal. For example, a project may have a goal of designing, developing, or creating a product. A process is any sequence of discrete events that has a discrete beginning and a discrete end. An event in the sequence of events may be thought of as a task, so that a process may include one or more events or tasks. That is, a project may include one more processes, wherein each process is directed to achieving, at least in part, the goal or goals of the project. Thus, for example, a project may be a software development project and may have a goal of producing a commercial software product. A process may be defined for achieving the project goal and may include a number of tasks.

Another embodiment of the invention is directed to generating project management artifacts. A project management artifact, as used herein, is any document or project deliverable that relates to an aspect of project management. An initial project plan may include artifacts such as a budget and a project schedule. As the requirements of the project change over time, it may be desirable to update the project artifacts to reflect the change in requirements. Rather than using software applications that allow manual creation and modification of such artifacts, such as application programs used to create and manipulate spreadsheets, application programs used to create flowcharts, and application programs used to create project schedules (e.g., Gantt charts), these artifacts may be automatically generated and updated based on a model of the process.

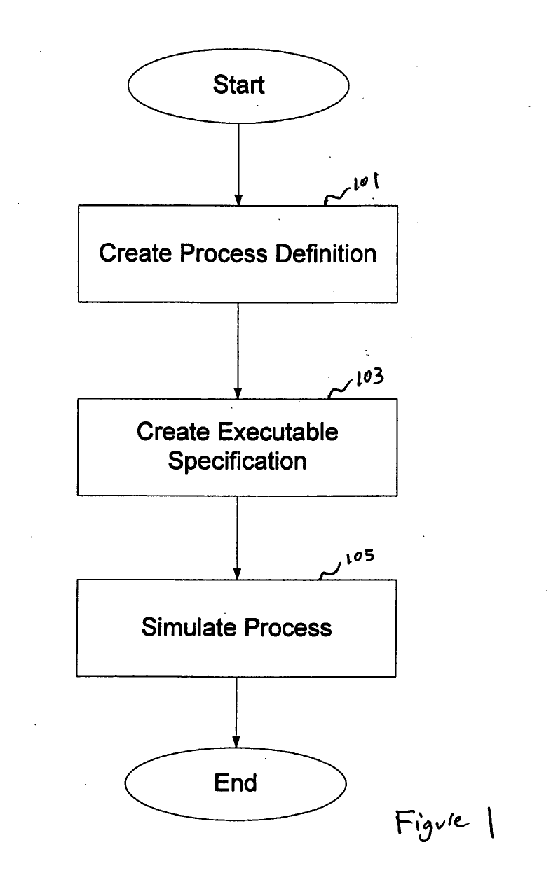

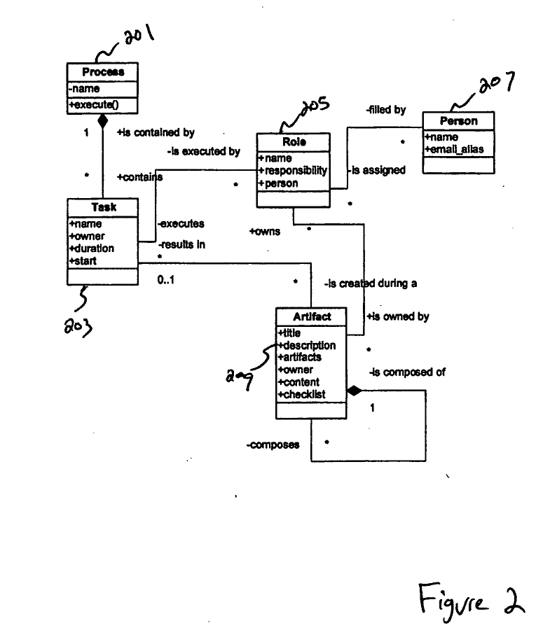

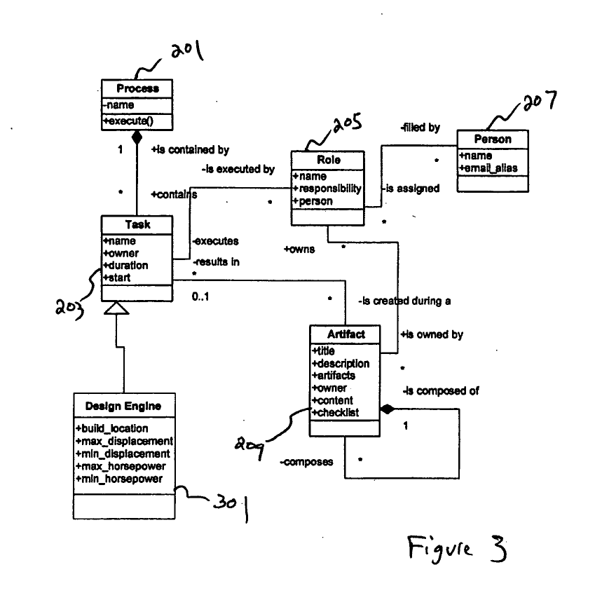

A flowchart for creating a process model for a process and for simulating the process is shown in FIG. 1. At step 101, a process definition may be created. Any suitable process definition may be used as the invention is not limited in this respect. A unified modeling language (UML) class diagram of one example of a process model is shown in FIG. 2. The process definition may be implemented in a programming language, for example so that each class in the UML class diagram is defined as an object-oriented class in the programming language and has the interrelations defined in the UML diagram. For example, as shown in FIG. 2, the process model includes a Process class 201. Process class 201 includes one data element (i.e., the variable name) that defines the name of the process and one method (i.e., execute) that executes a simulation of the process. Further, the Process class 201 also includes at least one of instances of Task class 203, as shown by the aggregation relationship between Process class 201 and Task class 203. Thus, a pseudocode example of an object-oriented class definition for the Process class is shown in Table 1.

TABLE 1

```
class Process{
    String name;
    Task* t;
    void execute( );
}
```

As shown in Table 1, the Process class includes a name, a plurality of tasks and an execute method. The execute method may be used, for example, to execute a simulation of the process.

As shown in the example process definition of FIG. 2, each instance of Task class 203 includes at least one instance of Role class 205 and at most one instance of Artifact class 209. Further, each instance of Role class 205 includes at least one instance of Person class 207. Thus, the process is defined such that it includes at least one task. Each task is executed by at least one role and results in zero or one artifacts. Each role is filled by at least one person and each artifact is owned by at least one role. The other classes and their interrelations may also be defined as object-oriented classes.

The example process definition of FIG. 2 defines the process at a very high level of abstraction. That is, the process definition defines the process at a high level so that it is applicable to many different processes and projects and is not specific to any particular process. For example, the process model of FIG. 2 may be used as a process for building an automobile and a process for developing a software product, as each of the building of an automobile and the development of software includes tasks that are executed by roles, wherein the roles are filled by people and the tasks may result in the generation of artifacts. However, the invention is not limited in this respect as the process definition may define the process at any level of abstraction. For example, a process definition may be created that is specific to the process of building an automobile. This may be done in any suitable way. For example, the process definition of FIG. 2 may be extended to include subclasses that define the process of building an automobile more specifically. For example, a new class Design Engine class 301 may be defined that is a subclass of Task class 203. Design Engine class 301 may inherit from Task class 301. That is, Design Engine class 301 may include all of the data elements and methods of its parent class (i.e., Task class 301) but may define its own additional data elements and methods. That is, like any instance of Task class 203, the task of designing an engine has a name, an owner, a duration, and a start time (inherited from the Task class). However, the task of designing an engine also has some elements that are specific to the task of designing an engine, such as a build location for the engine, minimum and maximum displacement requirements that the engine must satisfy and minimum and maximum horsepower requirements that the engine must satisfy. Thus, Design Engine class 301 may be thought of as a type of task that is specific to the process of building an automobile.

The process definition may be made even more specific (i.e., defined at a lower level of abstraction), for example, by breaking down the task of designing an engine into a number of smaller tasks and creating a subclass of Design Engine class 301 for each of these smaller tasks. Thus, for example, the task of designing an engine may be broken down into a number of smaller tasks, such as designing the engine block, designing the head, and designing the cams. Similarly, the process may be made more general, for example, by creating an even more abstract process definition.

Other classes in the process definition may also be created that are specific to the task of building an automobile. For example, Artifact class 209 may be extended to have a subclass Engine Blueprint which represents a blueprint of the engine design and includes data and methods specific to an engine blueprint. Role class 205 may be extended to have subclasses that represent roles specific to building an automobile (i.e., engineer, machinist, welder, etc.)

Subclasses that are specific to software development may be created in a process definition for a process of developing a software product. For example, instead of a Design Engine subclass of Task class 203, a process definition for developing a software product may include subclasses for tasks such as creating a requirements document, creating a functional specification, and creating a design specification. Such subclasses may inherit the data and methods defined by Task class 203 but may also define additional data elements and methods that are specific to those tasks.

In the examples described above, a process definition was implemented using object-oriented programming methodology. It should be appreciated that the invention is not limited in this respect, as project definitions need not be implemented or described in an object-oriented fashion and may be implemented in any suitable programming language. For example, a project definition may be implemented in object-oriented languages such as abstract state machine language (AsmL), Java, and C++, or may be implemented in a non-object-oriented language, such as C.

Further, in the examples above, a UML class diagram was used to illustrate the project definition. The invention is not limited in this respect and does not require specification or illustration in a UML class diagram or any other diagram. Indeed, as discussed below in greater detail a UML class diagram may be an artifact that is generated based on the process definition.

After a process definition is created in act 101 of FIG. 1, an executable specification may be created at act 102 that, when executed, simulates the process. A pseudocode example of a portion of an executable specification based on the process definition of FIG. 2 is shown in Table 2.

TABLE 2

line 1 Process P = new Process
line 2 P.t =new Task[3];
line 3 P.t[0].name = “Create Requirements Document”;
line 4 P.t[0].duration = 5;
line 5 P.t[0].start = “July 15, 2004”;
line 6 P.t[1].name = “Create Functional Specification”;
line 7 P.t[1].duration = 3;
line 8 P.t[1].start = “July 20, 2004”;
line 9 P.t[2].name = “Create Design Specification”;
line 10 P.t[2].duration = 7;
line 11 P.t[2].start = “July 23, 2004”;
line 12 P.execute( );

As shown in Table 2, at line 1 of the executable specification a Process object is instantiated. At line 2, three Task objects of the Process object are instantiated. Thus, the process comprises three tasks. At line 3, the name of the first Task object is defined as “Create Requirements Document” and at line 4 the duration of the first Task object is defined as 5, indicating that the task of creating a requirements document is estimated to take five days to complete. At line 5, the start date of the first Task object is defined as Jul. 15, 2004. Similarly, in lines 6-8 the name, duration, and start date of the second Task object are defined and in lines 9-11 the name, duration and start date of the third Task object are defined.

After the executable specification has been created at act 103 of FIG. 1, the process may be simulated by executing the executable specification at act 105. In line 12 of Table 2, the execute method of the Process object instantiated in line 1 is called. The execute method performs a simulation of the process. This may be done in any suitable way. For example, the execute method may check the process definition against a set of specified constraints and/or requirements. That is, the method may check, for example, that all tasks have a defined owner, or may check that no task may begin until all previously started tasks have been completed. In the example shown in Table 2, none of the Task objects has defined owners and therefore would not meet this requirement. In one embodiment, the failure to meet this requirement may be detected by the execute method and an alert may be generated.

It should be appreciated that the requirements described above are only examples of requirements against which a process definition may be checked. Indeed, any suitable requirements or constraints may be used as the invention is not limited in this respect.

In one embodiment, the execute method may, in addition or as an alternative, to checking the process definition against a set of requirements, examine the impact of changes in budget, resources, or scope. For example, a simulation of the process in which three people are assigned to work on one particular to task may be run to determine the cost of the process and time of completion. The process definition may then be changed to assign five people to work on one particular task and the simulation may be run again to determine how this change effects the cost and time of completion of the project. Thus, for example, a Monte Carlo simulation of the process may be run in which one or more parameters of the process model are changed in each simulation run and the results of those simulation runs may be analyzed, for example, to determine best case, average case, and worse case scenarios.

Any suitable parameters may be altered and simulations may be run to determine the effect of the change of these parameters on the process, as the invention is not limited in this respect. For example, parameters that may be altered include the number of tasks, the number of people assigned to each task, the time of completion of a tasks, the start date of a task, the cost of a task, whether certain tasks are performed in sequence or in parallel, or any other suitable parameters.

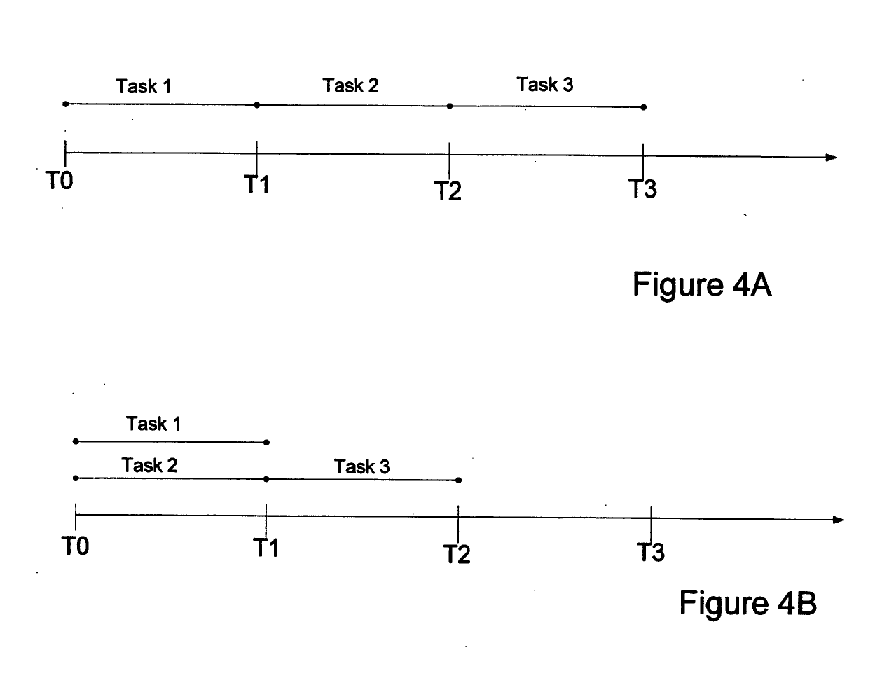

In one embodiment, the simulation of the process may be used to determine the completion date for the process. For example, as shown in FIG. 4A, a process includes three tasks: Task 1, Task 2, and Task 3. The process model may specify that start time of Task 1 (i.e., T0) and may specify the duration of all three tasks, but may not specify the start time of Task 2 and Task 3. The executable specification may indicate that Task 1, Task 2, and Task 3 are to be executed sequentially. Based on this information, and the duration of each Task, the simulation may determine the start time and end time of each task. For example, as shown in FIG. 4A, because it is known that Task 2 begins after Task 1 ends, it may be determined that Task 2 begins at time T1. Similarly, the duration of Task 2 is known, so it may be determined that Task 2 ends at time T2 and Task 3 begins at time T2. The duration of Task 3 is also specified so that it may be determined that Task 3 is completed at time T3. Thus, by simulating the execution of these tasks sequentially it may be determined that the completion time of the process is time T3. A pseduocode example of such a simulation is shown in Table 3.

TABLE 3

currentTime = Task1.execute(currentTime);
currentTime = Task2.execute(currentTime);
currentTime = Task3.execute(currentTime);
return currentTime;

In some processes, two or more tasks may be executed in parallel, for example, when execution of one task is not dependent on the results of the other tasks. That is, a first task may be to create a list of requirements that a software product is to satisfy, while a second task may be to determine an estimated cost of satisfying each requirement in the list. The second task requires the results of the first task, thus these tasks may not be performed in parallel. However, other tasks may be performed in parallel (e.g., concurrently). As used herein, performing two or more tasks in parallel means performing two tasks at the same time or beginning performance of one task before completion of another task that was started at an earlier time. For example, if a first task is to program a first software module and a second task is to program a second software module, wherein the first software module is not needed to program the second software module, the two software modules may be programmed in parallel.

Thus, in one embodiment of the invention, simulation of the process may simulate execution of tasks in parallel. For example, as shown in FIG. 4B, Task 1 and Task 2 may begin at time T0 and end at T1. Task 3 may begin at time T1 and complete at Time T2. Thus, by simulating the execution of Task 1 and Task 2 in parallel, it may be determined that the total completion time of the process is time T2, as opposed to a completion time of time T3, as is the case when the tasks are executed sequentially.

A pseudocode example of an executable specification that simulates the execution of tasks in parallel is shown in Table 4.

TABLE 4

```
execute parallel {
    stateTrajectory = Task1.execute(stateTrajectory);
    stateTrajectory = Task2.execute(stateTrajectory);
}
stateTrajectory = Task3.execute(stateTrajectory)
return stateTrajectory;
```

In the example of Table 4, a keyword (i.e., parallel) is used to indicate that performance of Task 1 and Task 2 is to be simulated in parallel. It should be appreciated that some programming languages provide built in functionality that allows methods to be treated as if they were performed in parallel. In such languages, a keyword, such as parallel may be used to indicate that performance of two or more methods is to be simulated in parallel. An example of a programming language with built in parallel execution functionality is abstract state machine language (AsmL).

However, it should be appreciated that the invention is not limited to use with programming languages that have built in parallel execution functionality. Indeed, any suitable programming language may be used as the invention is not limited in this respect.

As discussed above, in one embodiment of the invention, the executable specification may be used to generate project management artifacts, for example, using the information in the process definition. For example, a process flow chart may be generated based on the tasks in the project module and the sequence in which the tasks are to be executed. Other artifacts may be generated such as Gantt charts, PERT charts, or state trajectory charts. Indeed, any suitable artifact may be generated as the invention is not limited in this respect.

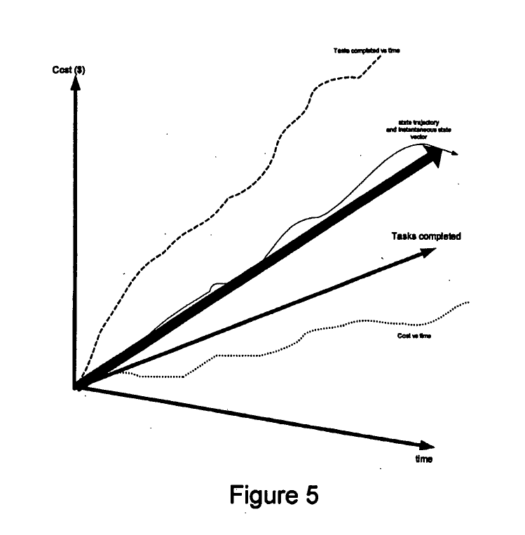

For example, a state trajectory diagram that plots the cost and tasks completed of a project versus time may be generated from the information in the process definition. An example of such a state trajectory diagram is shown in FIG. 5. As shown in FIG. 5, a vector in three dimensional vector space may be generated that shows the state of the process in terms of cost and tasks completed at a given time. Further, as progress on the process moves forward, the cost of the project may be plotted versus time and the number of tasks completed may be plotted versus time.

A pseudocode example of an executable specification that may be used to determine state trajectory is shown in Table 5.

```
TABLE 5
SequentialTasks(M as StateTrajectory) as StateTrajectory
  step var localM as StateTrajectory = M // local copy of state trajectory
  // create the task objects
  step var task1 as Task = new Task(“task 1”,null,“”,“”)
  step var task2 as Task = new Task(“task 2”,null,“”,“”)
  step var task3 as Task = new Task(“task 3”,null,“”,“”)
  // now execute them in sequence
  step localM := task1.Execute(localM) // execute task 1
  step localM := task2.Execute(localM) // execute task 2
  step localM := task3.Execute(localM) // execute task 3
  step return localM as StateTrajectory
```

In one embodiment of the invention, automated tasks may be modeled in a process definition. That is, both tasks that are performed by humans and tasks that are performed automatically (e.g., by computers) may be modeled. By modeling that tasks that are performed automatically, the executable simulation may generate software code, which when executed by a computer, performs the automatic task.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of managing a project comprising acts of:
defining a process model for a process in a programming language, wherein the process model includes an executable specification of the process; and
executing the specification on a computer system to simulate the process.

2. The method of claim 1, wherein the act of executing the specification further comprises an act of generating at least one project management artifact.

3. The method of claim 1, wherein the process comprises a sequence of discrete events.

4. The method of claim 1, wherein the project includes a goal of creating a product and wherein the process defines a method of achieving, at least in part, the goal of producing a product.

5. The method of claim 1, wherein the process model defines a plurality of tasks and wherein the act of executing the specification further comprises an act of simulating performance of at least two of the plurality of tasks in parallel.

6. The method of claim 1, wherein the process model defines a plurality of tasks and wherein the act of executing the specification further comprises an act of simulating performance of at least two of the plurality of tasks in sequence.

7. The method of claim 2, wherein the at least one project management artifact includes a project schedule.

8. The method of claim 2, wherein the at least one project management artifact includes a project flowchart.

9. The method of claim 2, wherein the at least one project management artifact includes a state trajectory diagram.

10. The method of claim 1, wherein the act of executing the process further comprises an act of performing a Monte Carlo simulation of the process.

11. The method of claim 1, wherein the project is a first project and the method further comprises an act of:
reusing the process model for a second project.

12. The method of claim 1, wherein the act of defining the process model further comprises an act of defining the process model at at least two different levels of abstraction.

13. At least one computer readable medium encoded with instructions that, when executed on a computer system, perform a method of managing a project comprising acts of:
accepting as an input a process model for a process, wherein the process model includes an executable specification of the process; and
simulating the process by executing the specification on the computer system.

14. The at least one computer readable medium of claim 13, wherein the act of executing the specification further comprises an act of generating at least one project management artifact.

15. The at least one computer readable medium of claim 13, wherein the process comprises a sequence of discrete events.

16. The at least one computer readable medium of claim 13, wherein the project includes a goal of creating a product and wherein the process defines a method of achieving, at least in part, the goal of producing a product.

17. The at least one computer readable medium of claim 13, wherein the process model defines a plurality of tasks and wherein the act of executing the specification further comprises an act of simulating performance of at least two of the plurality of tasks in parallel.

18. The at least one computer readable medium of claim 13, wherein the process model defines a plurality of tasks and wherein the act of executing the specification further comprises an act of simulating performance of at least two of the plurality of tasks in sequence.

19. The at least one computer readable medium of claim 14, wherein the at least one project management artifact includes a project schedule.

20. The at least one computer readable medium of claim 14, wherein the at least one project management artifact includes a project flowchart.

21. The at least one computer readable medium of claim 14, wherein the at least one project management artifact includes a state trajectory diagram.

22. The at least one computer readable medium of claim 13, wherein the act of executing the process further comprises an act of performing a Monte Carlo simulation of the process.

23. The at least one computer readable medium of claim 13, wherein the project is a first project and the method further comprises an act of:
reusing the process model for a second project.

24. The at least one computer readable medium of claim 13, wherein the act of accepting as an input a process model for a process further comprises an act of accepting as input the process model at at least two different levels of abstraction.

25. An apparatus for use in managing a project comprising:
an input adapted to receive an executable specification of a process; and
at least one controller adapted to simulate the process by executing the specification.

26. The apparatus of claim 25, wherein the at least one controller is adapted to generate at least one project management artifact based, at least in part, on execution of the specification.

27. The apparatus of claim 25, wherein the process comprises a sequence of discrete events.

28. The apparatus of claim 25, wherein the project includes a goal of creating a product and wherein the process defines a method of achieving, at least in part, the goal of producing a product.

29. The apparatus of claim 25, wherein the process model defines a plurality of tasks and wherein the at least one controller is adapted to simulate performance of at least two of the plurality of tasks in parallel.

30. The apparatus of claim 25, wherein the process model defines a plurality of tasks and wherein the at least one processor is adapted to simulate performance of at least two of the plurality of tasks in sequence.

31. The apparatus of claim 26, wherein the at least one project management artifact includes a project schedule.

32. The apparatus of claim 26, wherein the at least one project management artifact includes a project flowchart.

33. The apparatus of claim 26, wherein the at least one project management artifact includes a state trajectory diagram.

34. The apparatus of claim 25, wherein the at least one controller is adapted to perform a Monte Carlo simulation of the process.
